(19) United States
(12) Patent Application Publication
(10) Pub. No.: US 2025/0297393 A1
(43) Pub. Date: Sep. 25, 2025

(54) CO2 CONVERSION METHOD

(71) Applicant: HONDA MOTOR CO., LTD., Tokyo (JP)

(72) Inventors: Hiroshi Oikawa, Wako-shi (JP); Yuta Shimada, Wako-shi (JP)

(21) Appl. No.: 19/074,505

(22) Filed: Mar. 10, 2025

(30) Foreign Application Priority Data
Mar. 22, 2024 (JP) 2024-046464

(51) Int. Cl. C25B 15/08; C01B 32/40; C25B 1/04; C25B 3/03

(52) U.S. Cl. CPC C25B 15/081; C01B 32/40; C25B 1/04; C25B 3/03

(57) ABSTRACT

A CO₂ conversion method includes: generating CO and H₂O by a RWGS reaction from CO₂ and H₂; generating C₂H₄ and H₂ by CO electrolysis from the CO and H₂O; and using the H₂ generated by the CO electrolysis as the H₂ of the RWGS reaction.

### CROSS-REFERENCE TO RELATED APPLICATION

Priority is claimed on Japanese Patent Application No. 2024-046464, filed on Mar. 22, 2024, the contents of which are incorporated herein by reference.

### BACKGROUND

### Field of the Invention

The present invention is an invention according to a CO₂ conversion method.

### Background

In the related art, efforts aiming at reduction of the impact on or moderation of climate change have been ongoing, and toward the realization of this purpose, research and development relating to effective utilization of CO₂ has been conducted.

CO₂ is generated by a number of industrial and biological processes. CO₂ is commonly discharged into air. However, since CO₂ is recognized as a greenhouse effect gas, it is necessary to reduce CO₂ discharged from these processes. CO₂ can be used in order to facilitate the recovery of oil and a gas from an oil well in limited cases, but most of the recovered CO₂ is discharged to air.

### SUMMARY

In the reduction of CO₂ emissions, it is a problem to effectively utilize CO₂ as a raw material of other products without discharging CO₂ into air.

As a method for effectively utilizing CO₂, for example, a method as described in Published Japanese Translation No. 2023-527651 of the PCT International Publication is known in which CO₂ is converted into CO by utilizing a reverse water gas shift (RWGS) reaction (CO₂+H₂→CO+H₂O), and then a lower olefin such as ethylene (C₂H₄) is produced. If there are CO (carbon monoxide) generated by the RWGS reaction and hydrogen from electrolysis of water, a valuable chemical raw material can be obtained via catalytic hydrogenation from carbon monoxide to carbon hydride. However, in this method, since a reaction using a catalyst is utilized, a by-product such as methanol is generated, a step of conversion into a lower olefin is required, and therefore, there is a problem that the number of steps is increased. Further, there is a problem that the equipment cost and input energy are increased.

An aspect of the present invention aims at providing a CO₂ conversion method that can efficiently obtain ethylene from CO generated from a RWGS reaction. Further, the aspect of the present invention contributes to a reduction of the impact on or to moderation of climate change.

A CO₂ conversion method according to a first aspect of the present invention includes: generating CO and H₂O by a RWGS reaction from CO₂ and H₂; generating C₂H₄ and H₂ by CO electrolysis from the CO and H₂O; and using the H₂ generated by the CO electrolysis as the H₂ of the RWGS reaction.

A second aspect is the CO₂ conversion method according to the first aspect, wherein a C₂H₄ current efficiency in the CO electrolysis may be 66.6% or less.

A third aspect is the CO₂ conversion method according to the first or second aspect, wherein the H₂ generated by the CO electrolysis may be used as the H₂ of the RWGS reaction and a heat source.

A fourth aspect is the CO₂ conversion method according to the third aspect, wherein the C₂H₄ current efficiency in the CO electrolysis may be set to be equal to or more than a value where excess H₂ is not generated in accordance with a H₂ thermal efficiency.

According to the aspect described above of the present invention, it is possible to provide a CO₂ conversion method that can efficiently obtain ethylene from CO generated from a RWGS reaction.

### BRIEF DESCRIPTION OF THE DRAWINGS

FIG. 1 is a graph showing a relationship between C₂H₄ current efficiency in a CO electrolysis cell and consumption CO amount/generation H₂ amount in the CO electrolysis cell.

FIG. 2 is a graph showing a relationship between H₂ thermal efficiency and C₂H₄ current efficiency.

FIG. 3 is a graph showing a relationship between C₂H₄ current efficiency in the CO electrolysis cell and a supply-demand heat quantity difference of H₂ and excess H₂ when the H₂ thermal efficiency is set to 75%.

### DESCRIPTION OF EMBODIMENTS

Hereinafter, embodiments of the present invention is described with reference to the drawings. The embodiments shown in the following description are merely examples, and the present invention is not necessarily limited thereto and can be appropriately modified and implemented without departing from the scope of the invention.

A CO₂ conversion method according to the present embodiment generates CO and H₂O by a RWGS reaction from CO₂ and H₂ and generates C₂H₄ and H₂ by a CO electrolysis cell from the CO and H₂O.

In the RWGS reaction, the following reaction occurs. A reactor and a heat condition for the RWGS reaction are not particularly limited.

CO₂+H₂→CO+H₂O (ΔH=41.2 kJ/mol)

In CO electrolysis, the following reaction occurs. For example, a CO electrolysis cell can be used for the CO electrolysis. A specific configuration of the CO electrolysis cell and the like are not particularly limited as long as C₂H₄ and H₂ are generated by a reaction described below. Further, H₂O used in the reaction described below may be generated by the RWGS reaction or may be supplied from another supply source.

2CO+6H₂O+8e⁻→C₂H₄+8OH⁻

2H₂O+2e⁻→H₂+2OH⁻

In the CO₂ conversion method according to the present embodiment, since CO generated by the RWGS reaction can be converted into C₂H₄ by the CO electrolysis, it is possible to decrease the number of steps and decrease the equipment cost and the energy amount that are input.

Further, in the CO₂ conversion method according to the present embodiment, H₂ generated by the CO electrolysis is used as H₂ of the RWGS reaction. Thereby, it possible to omit the introduction of a water electrolysis device or the like for producing H₂ used in the RGWS reaction and a water electrolysis step.

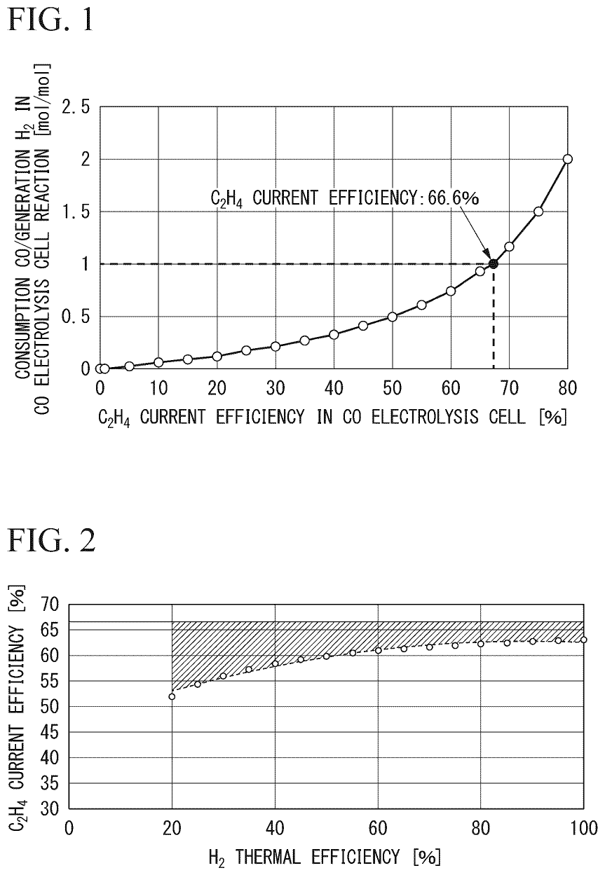

FIG. 1 is a graph showing a relationship between a C₂H₄ current efficiency in the CO electrolysis of the CO electrolysis cell and a consumption CO amount/generation H₂ amount in the CO electrolysis of the CO electrolysis cell. As shown in FIG. 1, when the C₂H₄ current efficiency in the CO electrolysis is 66.6% (and a H₂ current efficiency is 33.4%), it is possible to equalize a mol amount of CO consumed by the RWGS reaction to a mol amount of H₂ generated by the CO electrolysis. That is, by setting the C₂H₄ current efficiency in the CO electrolysis is 66.6% or less (and the H₂ current efficiency is 33.4% or more), it is possible to cover H₂ required for the RWGS reaction only by H₂ generated by the CO electrolysis, and it is possible to perform a CO₂ conversion continuously without requiring the supply from another H₂ supply source. Therefore, the C₂H₄ current efficiency of the CO electrolysis cell can be preferably 66.6% or less.

H₂ generated by the CO electrolysis can be preferably used as a heat source of the RWGS reaction in addition to being used as H₂ of the RWGS reaction. Since the RWGS reaction is an endothermic reaction, a heat quantity is required for the reaction. Therefore, H₂ generated by the CO electrolysis is combusted and is used as a heat source of the RWGS reaction, and thereby, it becomes unnecessary to supply the heat quantity from another supply source. Thereby, it is possible to further reduce input energy for CO₂ conversion.

Here, the C₂H₄ current efficiency in the CO electrolysis can be preferably set to a value that is equal to or more than a value where excess H₂ is not generated in accordance with a thermal efficiency (H₂ thermal efficiency) when H₂ is used as a heat source.

When H₂ is used as a heat source, a H₂ consumption width in the CO₂ conversion method according to the present embodiment can be represented by the following expression.

$$RWGS endothermic enthalpy ( kJ / mol ) \times CO generation amount in RWGS reaction ( mol / h ) \geq {H}_{2} combustion enthalpy ( kJ / mol ) \times electrolysis {H}_{2} generation amount ( mol / h ) \times {H}_{2} thermal efficiency ( \% )$$

Here, the RWGS endothermic enthalpy is ΔH=41.2 kJ/mol, and the H₂ combustion enthalpy is ΔH=241.82 kJ/mol.

The CO generation amount in the RWGS reaction is equal to an electrolysis CO consumption amount and is equal to an electrolysis C₂H₄ generation amount×2. The electrolysis C₂H₄ generation amount can be represented by the following expression.

$$Cell current ( A ) / Faraday constant ( ( A \cdot sec . ) / mol - e ) \times {C}_{2} {H}_{4} current efficiency ( \% )$$

The electrolysis H₂ generation amount can be represented by the following expression.

$$Cell current ( A ) / Faraday constant ( ( A \cdot sec . ) / mol - e ) \times {H}_{2} current efficiency ( \% )$$

FIG. 2 shows a relationship between a H₂ thermal efficiency and a C₂H₄ current efficiency from a H₂ consumption width obtained by the method described above. An approximate curve shown in FIG. 2 is a curve of y=−0.0021x²+0.3654x+46.557. In the case where a certain constant H₂ thermal efficiency is specified, when the C₂H₄ current efficiency in the CO electrolysis is lower than a curve in FIG. 2, excess H₂ is generated by the CO electrolysis. Since the excessively generated H₂ needs to be consumed by another device, the increase of the number of steps occurs. Therefore, the C₂H₄ current efficiency in the CO electrolysis can be preferably set to a value that is equal to or more than a value where excess H₂ is not generated in accordance with the H₂ thermal efficiency.

For example, when the H₂ thermal efficiency is 75%, as shown in FIG. 2, by setting the C₂H₄ current efficiency to 62.0% or more, it is possible to prevent excess H₂ by the CO electrolysis from being generated.

Here, when H₂ is combusted as a heat source, thermal energy of 241.82 kJ/mol is generated by the following reaction.

½O₂+H₂→H₂O (ΔH=−241.82 kJ)

If the H₂ thermal efficiency when H₂ is used as a heat source is assumed to be 75%, a heat quantity of 241.82×0.75=181.37 kJ/mol is obtained, and in the RWGS reaction, a heat quantity of 181.37/41.2=4.4 kJ/mol per CO: 1 mol can be covered.

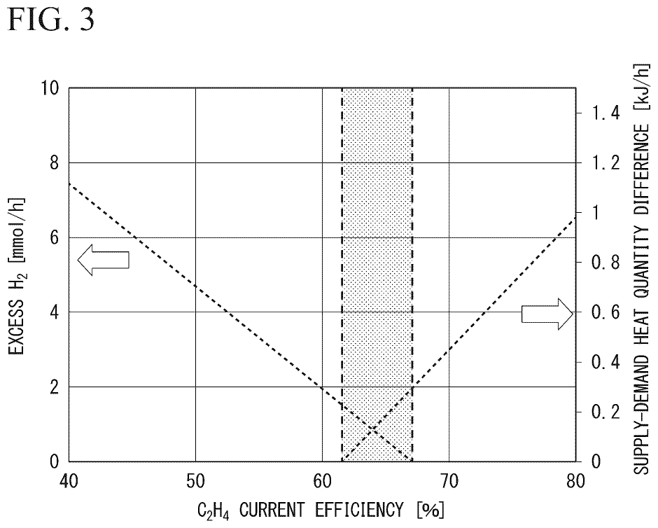

FIG. 3 shows a relationship between a C₂H₄ current efficiency in the CO electrolysis and a supply-demand heat quantity difference of H₂ and excess H₂ when the H₂ thermal efficiency is set to 75%. The positive value of the supply-demand heat quantity difference of H₂ indicates that a H₂ amount supplied from the CO electrolysis to the RWGS reaction is larger than a H₂ amount (both of H₂ used for the reaction and H₂ as a heat source) required for the RWGS reaction. Further, the positive value of excess H₂ indicates that a H₂ amount generated by the CO electrolysis is larger than a H₂ amount (excluding H₂ as a heat source) required for the RWGS reaction.

As shown in FIG. 3, in the case where the H₂ thermal efficiency when H₂ is used as a heat source is assumed to be 75%, by setting the C₂H₄ current efficiency in the CO electrolysis to 62.0 to 66.6% (and the H₂ current efficiency is 33.4 to 38.0%), without requiring a supply from another H₂ supply source, and without generating excess H₂ by the CO electrolysis, it is possible to further efficiently perform a CO₂ conversion. Therefore, when the H₂ thermal efficiency is set to 75%, the C₂H₄ current efficiency in the CO electrolysis can be preferably 62.0 to 66.6%.

What is claimed is:

1. A CO₂ conversion method comprising:
generating CO and H₂O by a RWGS reaction from CO₂ and H₂;
generating C₂H₄ and H₂ by CO electrolysis from the CO and H₂O; and
using the H₂ generated by the CO electrolysis as the H₂ of the RWGS reaction.

2. The CO₂ conversion method according to claim 1,
wherein a C₂H₄ current efficiency in the CO electrolysis is 66.6% or less.

3. The CO₂ conversion method according to claim 1,
wherein the H₂ generated by the CO electrolysis is used as the H₂ of the RWGS reaction and a heat source.

4. The CO₂ conversion method according to claim 3,
wherein a C₂H₄ current efficiency in the CO electrolysis is set to be equal to or more than a value where excess H₂ is not generated in accordance with a H₂ thermal efficiency.

5. The CO₂ conversion method according to claim 2,
wherein the H₂ generated by the CO electrolysis is used as the H₂ of the RWGS reaction and a heat source.

6. The CO₂ conversion method according to claim 5,
wherein a C₂H₄ current efficiency in the CO electrolysis is set to be equal to or more than a value where excess H₂ is not generated in accordance with a H₂ thermal efficiency.
